(19) United States
(12) Patent Application Publication
(10) Pub. No.: US 2026/0128327 A1
(43) Pub. Date: May 7, 2026

(54) ALL-SOLID-STATE BATTERY AND MANUFACTURING METHOD THEREOF

(71) Applicant: SAMSUNG ELECTRO-MECHANICS CO., LTD., Suwon-si, Gyeonggi-do (KR)

(72) Inventors: Youngjin Hwang, Suwon-si, Gyeonggi-do (KR); Youn Gyu Han, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/293,660

(22) PCT Filed: Jan. 8, 2024
(86) PCT No.: PCT/KR2024/000314

§ 371 Date: Jan. 30, 2024

(30) Foreign Application Priority Data
Sep. 13, 2023 (KR) 10-2023-0121941

(51) Int. Cl. H01M 4/72; H01M 4/04; H01M 4/36; H01M 10/0562; H01M 10/0585; H01M 50/54

(52) U.S. Cl. CPC H01M 4/72; H01M 4/0473; H01M 4/366; H01M 10/0562; H01M 10/0585; H01M 50/54

(57) ABSTRACT

An all-solid-state battery includes: a solid electrolyte layer; and a first electrode layer and a second electrode layer arranged with the solid electrolyte layer therebetween. The first electrode layer and second electrode layer respectively include a current collector including first current collecting portions spaced from each other by through holes in a first direction and second current collecting portions spaced from each other by the through holes in a second direction that is vertical to the first direction and crossing the first current collecting portions, and an electrode active material layer including a first layer disposed on one surface of the current collector and a second layer disposed in the through holes in the current collector.

### TECHNICAL FIELD

The present disclosure relates to an all-solid-state battery and a manufacturing method thereof.

### BACKGROUND ART

As long-term use of portable electronic devices becomes more common, there is a demand for higher-capacity batteries, and with the spread of wearable electronic devices, there is a need to ensure battery safety. Therefore, the development of an all-solid-state battery that uses solid state electrolytes instead of liquid electrolytes is actively underway.

The all-solid-state battery is a battery that replaces the existing liquid electrolyte with a solid-state electrolyte. It may greatly improve the risk of explosion due to the flammability of liquid electrolyte, and does not use the liquid electrolyte, so a stable operation is also possible in relatively harsh environments of high temperature and high pressure. In addition, since cells may be stacked without a separate cooling unit and high energy density may be achieved in the same volume, its future use is expected.

### DISCLOSURE OF INVENTION

### Technical Problem

The present disclosure attempts to provide an all-solid-state battery for increasing an amount of an active material within a given volume and resultantly increasing energy density and capacity, and a manufacturing method thereof.

However, tasks to be solved by embodiments of the present disclosure may not be limited to the above-described task, and may be extended in various ways within a range of technical scopes included in the present disclosure.

### Solution to Problem

An embodiment of the present disclosure provides an all-solid-state battery including: a solid electrolyte layer; and a first electrode layer and a second electrode layer arranged with the solid electrolyte layer therebetween. The first electrode layer and second electrode layer respectively include a current collector including first current collecting portions spaced from each other by through holes in a first direction and second current collecting portions spaced from each other by the through holes in a second direction that is vertical to the first direction and crossing the first current collecting portions, and an electrode active material layer including a first layer disposed on one surface of the current collector and a second layer disposed in the through holes in the current collector.

The first current collecting portions may extend in parallel to the second direction, and the second current collecting portions may extend in parallel to the first direction.

The current collector may include one pair of first current collecting portions disposed on an outer portion from among the first current collecting portions and one pair of second current collecting portions disposed on an outer portion from among the second current collecting portions to contact each other at both ends to have a quadrangular frame shape.

From among the first current collecting portions of the first electrode layer, the first current collecting portion disposed on an outermost portion of one side may contact a first external electrode disposed on one sides of the first electrode layer and the second electrode layer.

The all-solid-state battery may further include a second external electrode disposed on one sides of the first electrode layer and the second electrode layer to be in contact with a first current collecting portion disposed on an outermost portion from among the first current collecting portions of the second electrode layer.

The all-solid-state battery may further include a first external electrode disposed on other sides of the first electrode layer and the second electrode layer to be in contact with a first current collecting portion disposed on an outermost portion from among the first current collecting portions of the first electrode layer. The through holes may be arranged in an array in the first direction and the second direction.

Another embodiment of the present disclosure provides an all-solid-state battery including: a solid electrolyte layer; and a first electrode layer and a second electrode layer arranged with the solid electrolyte layer therebetween. The first electrode layer and the second electrode layer respectively include a current collector including an active material receiving portion, and an electrode active material layer disposed in the active material receiving portion and disposed on at least one surface of the current collector. The active material receiving portion includes through holes spaced from each other in a first direction and a second direction that is vertical to the first direction in the current collector.

The current collector may include first current collecting portions spaced from each other in the first direction with the through holes therebetween, and second current collecting portions spaced from each other in the second direction with the through holes therebetween.

The first current collecting portions and the second current collecting portions may have portions crossing each other.

The electrode active material layer may include a first layer disposed on one surface of the current collector, a second layer disposed in the through holes, and a third layer disposed on the other surface of the current collector, and the first layer and the third layer may be integrally connected to each other by the second layer.

Another embodiment of the present disclosure provides a method for manufacturing an all-solid-state battery including: forming an electrode layer on a solid electrolyte layer; and repeatedly stacking the solid electrolyte layer and the electrode layer. The forming of the electrode layer includes forming a first active material layer on the solid electrolyte layer, forming a current collector having through holes in the first active material layer, forming second active material layers to fill the through holes, and forming a third active material layer on the current collector and the second active material layers. The forming of the current collector includes forming first current collecting portions spaced from each other in the first direction and second current collecting portions spaced from each other in a second direction that is vertical to the first direction and crossing the first current collecting portions.

The first current collecting portions may be formed to be parallel to the second direction, and the second current collecting portions may be formed to be parallel to the first direction.

The forming of the current collector may include one pair of first current collecting portions disposed on an outer portion from among the first current collecting portions and one pair of second current collecting portions disposed on an outer portion from among the second current collecting portions to contact each other at both ends and have a quadrangular frame shape.

### Advantageous Effects of Invention

According to the all-solid-state battery according to the embodiment, the amount of the active material may be increased without increasing the volume. Therefore, the all-solid-state battery according to the embodiment may increase the energy density and the capacity within the given volume.

### BRIEF DESCRIPTION OF DRAWINGS

FIG. 1 shows a perspective view of an all-solid-state battery according to an embodiment.

FIG. 2 shows a cross-sectional view of an all-solid-state battery with respect to a line II-II′ of FIG. 1.

FIG. 3 shows a cross-sectional view of an all-solid-state battery with respect to a line III-III′ of FIG. 1.

FIG. 4 shows a perspective view of a positive electrode layer in an all-solid-state battery shown in FIG. 1.

FIG. 5 shows an exploded perspective view of a positive electrode layer shown in FIG. 4.

FIG. 6 shows a perspective view of a negative electrode layer in an all-solid-state battery shown in FIG. 1.

FIG. 7 shows an exploded perspective view of a negative electrode layer shown in FIG. 6.

FIG. 8 to FIG. 12 show processes of a first stage in a method for manufacturing an all-solid-state battery according to an embodiment.

FIG. 13 to FIG. 17 show processes of a second stage in a method for manufacturing an all-solid-state battery according to an embodiment.

FIG. 18 shows a process of a third stage in a method for manufacturing an all-solid-state battery according to an embodiment.

### MODE FOR THE INVENTION

In the following detailed description, only certain embodiments of the present disclosure have been shown and described, simply by way of illustration. The drawings and description are to be regarded as illustrative in nature and not restrictive. Like reference numerals designate like elements throughout the specification. Some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and substitutions without departing from the scope and spirit of the present disclosure

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. The word “on” or “above” means disposed on or below the object portion, and does not necessarily mean disposed on the upper side of the object portion based on a gravitational direction.

It should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

The phrase “in a plan view” or “on a plane” means viewing a target portion from the top, and the phrase “in a cross-sectional view” or “on a cross-section” means viewing a cross-section formed by perpendicularly cutting a target portion from the side.

Throughout the specification, when it is described that a part is “connected” to another part, the part may be “directly connected” to the other element, may be “connected” to the other part through a third part, or may be connected to the other part physically or electrically, and may be referred to by different titles depending on dispositions or functions, but respective portions that are substantially integrated into one body may be connected to each other.

In description of an all-solid-state battery in this specification, a direction in which main components of the all-solid-state battery are stacked is defined as a stacking direction, but may also be a thickness direction. In addition, a direction parallel to a plane perpendicular to the stacking direction may be defined as a planar direction, and the plane direction may include a first direction and a second direction orthogonal to each other.

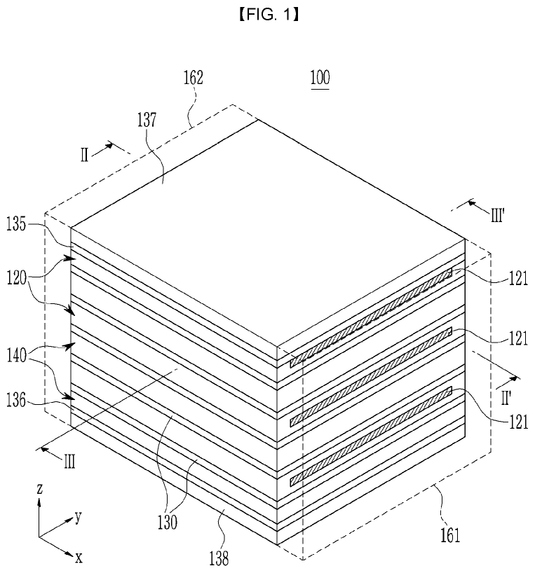

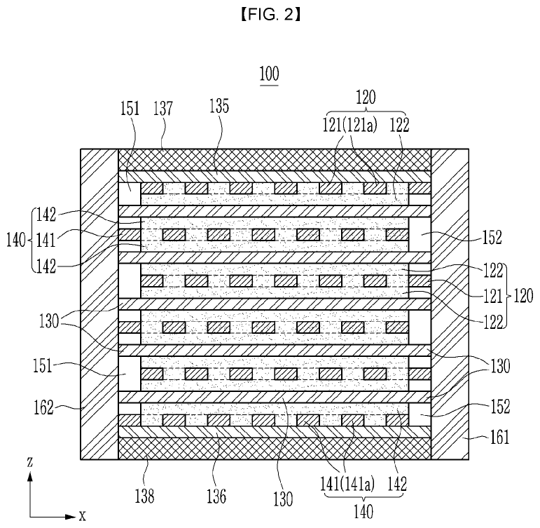

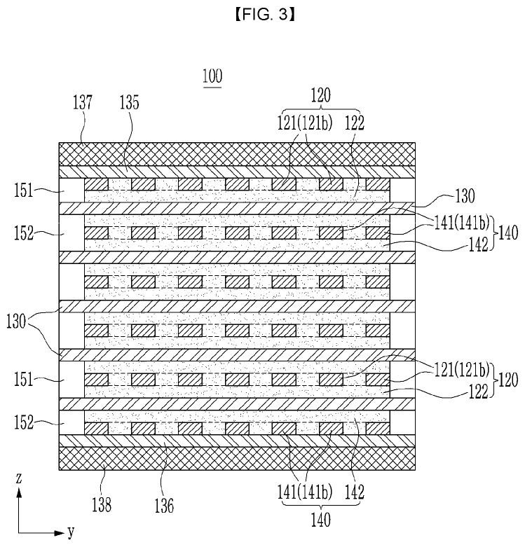

FIG. 1 shows a perspective view of an all-solid-state battery according to an embodiment. FIG. 2 shows a cross-sectional view of an all-solid-state battery with respect to a line II-II′ of FIG. 1, and FIG. 3 shows a cross-sectional view of an all-solid-state battery with respect to a line III-III′ of FIG. 1.

Referring to FIG. 1 to FIG. 3, the all-solid-state battery 100 includes electrode layers 120 and 140 and a solid electrolyte layer 130 disposed near the electrode layers 120 and 140 in a stacking direction (a z direction in the drawings). The electrode layers 120 and 140 may include current collectors 121 and 141 extending in the planar direction (the x-y direction in the drawings), and electrode active material layers 122 and 142 disposed on at least one surfaces of the current collectors 121 and 141.

The electrode layers 120 and 140 include a positive electrode layer 120 and a negative electrode layer 140 having different polarities. The solid electrolyte layer 130 may include a solidified electrolyte, and may function as a medium for transmitting ions between the positive electrode layer 120 and the negative electrode layer 140. The positive electrode layer 120 may be a first electrode layer, and the negative electrode layer 140 may be a second electrode layer. The positive electrode layer 120 may include a positive electrode current collector 121 and a positive active material layer 122 disposed on at least one surface of the positive electrode current collector 121. The negative electrode layer 140 may include a negative electrode current collector 141, and a negative active material layer 142 disposed on at least one surface of the negative electrode current collector 141.

For example, the positive electrode layer 120 disposed at an uppermost portion with respect to the stacking direction may include the positive active material layer 122 disposed on one surface (a lower surface) of the positive electrode current collector 121, and the negative electrode layer 140 disposed at a lowermost portion in the stacking direction may include the negative active material layer 142 disposed on one surface (an upper surface) of the negative electrode current collector 141. The positive electrode layers 120 disposed between the uppermost portion and the lowermost portion may include positive active material layers 122 disposed on both surfaces of the positive electrode current collector 121, and the negative electrode layers 140 disposed between the uppermost portion and the lowermost portion may include the negative active material layer 142 disposed on both surfaces of the negative electrode current collector 141.

The positive active material included in the positive active material layer 122 may include lithium (Li) ions. The positive active material may reversibly intercalate and de-intercalate the lithium ions. That is, the positive active material may, while including the lithium ions, provide the lithium ions to the negative electrode when the all-solid-state battery is charged. The positive active material may give an influence on capacity and outputs of the all-solid-state battery.

The positive active material may be a compound expressed in the following chemical formula: LiₐA_{l-b}M_{b}D₂ (where, 0.90≤a≤1.8, 0≤b≤0.5); LiₐE_{l-b}M_{b}O_{2-c}D_{c} (where, 0.90≤a≤1.8, 0≤b≤0.5, 0≤c≤0.05); LiE_{2-b}M_{b}O_{4-c}D_{c} (where, 0≤b≤0.5, 0≤c≤0.05); LiₐNi_{1-b-c}Co_{b}M_{c}D_{α} (where, 0.90≤a≤1.8, 0≤b≤0.5, 0≤c≤0.05, 0<α≤2); LiₐNi_{1-b-c}Co_{b}M_{c}O_{2-α}X_{α} (where, 0.90≤a≤1.8, 0≤b≤0.5, 0≤c≤0.05, 0<α<2); LiₐNi_{1-b-c}Co_{b}M_{c}O_{2-α}X₂ (where, 0.90≤a≤1.8, 0≤b≤0.5, 0≤c≤0.05, 0<α<2); LiₐNi_{1-b-c}Mn_{b}M_{c}D_{α} (where, 0.90≤a≤1.8, 0≤b≤0.5, 0≤c≤0.05, 0<α≤2); LiₐNi_{1-b-c}Mn_{b}M_{c}O_{2-α}X_{α} (where, 0.90≤a≤1.8, 0≤b≤0.5, 0≤c≤0.05, 0<α<2); LiₐNi_{1-b-c}Mn_{b}M_{c}O_{2-α}X₂ (where, 0.90≤a≤1.8, 0≤b≤0.5, 0≤c≤0.05, 0<α<2); LiₐNi_{b}E_{c}G_{d}O₂ (where, 0.90≤a≤1.8, 0≤b≤0.9, 0≤c≤0.5, 0.001≤d≤0.1); LiₐNi_{b}Co_{c}Mn_{d}GₑO₂ (where, 0.90≤a≤1.8, 0≤b≤0.9, 0≤c≤0.5, 0≤d≤0.5, 0.001≤e≤0.1); LiₐNiG_{b}O₂ (where, 0.90≤a≤1.8, 0.001≤b≤0.1); LiₐCoG_{b}O₂ (where, 0.90≤a≤1.8, 0.001≤b≤0.1); LiₐMnG_{b}O₂ (where, 0.90≤a≤1.8, 0.001≤b≤0.1); LiₐMn₂G_{b}O₄ (where, 0.90≤a≤1.8, 0.001≤b≤0.1); QO₂; QS₂; LiQS₂; V₂O₅; LiV₂O₂; LiRO₂; LiNiVO₄; Li_{(3-f)}J₂ PO₄₃ (0≤f≤2); Li_{(3-f)}Fe₂ PO₄₃ (where, 0≤f≤2); and LifePO₄, and in the chemical formula, A is Ni, Co, or Mn; M is Al, Ni, Co, Mn, Cr, Fe, Mg, Sr, V, Nb, Ti or rare-earth elements; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; and J is V, Cr, Mn, Co, Ni, or Cu.

The positive active material may be LiCoO₂, LiMnₓO₂ₓ (where, x=1 or 2), LiNi₁₋ₓMnₓO₂ₓ (where, 0<x<1), LiNi_{1-x-y}CoₓMn_{y}O₂ (where, 0≤x≤0.5, 0≤y≤0.5), LiFePO₄, TiS₂, FeS₂, TiS₃, or FeS₃, but is not limited thereto.

The positive active material may selectively include a conductive material and a binder. However, as an organic material such as the binder is decomposed at the time of sintering, it may not remain on the positive active material layer of the obtained positive electrode current collector.

The conductive material is not specifically limited as long as it does not generate a chemical change in the all-solid-state battery 100 and has conductivity. For example, graphite such as natural graphite or artificial graphite; a carbon-based material such as carbon black, acetylene black, ketjen black, channel black, furnace black, lamp black, or summer black; a conductive fiber such as carbon fiber or a metal fiber; a carbon fluoride; a metal component such as lithium (Li), tin (Sn), aluminum (Al), nickel (Ni), or copper (Cu), oxides thereof, a nitride, a fluoride, etc.; a conductive whisker such as a zinc oxide or a potassium titanate; a conductive metal oxide such as titanium oxide; and a conductive material such as a polyphenylene derivative may be used.

The binder may be used to improve bonding strength between the active material and the conductive material. The binder may, polyvinylidene fluoride, polyvinyl alcohol, carboxymethylcellulose (CMC), starch, hydroxypropyl cellulose, regenerated cellulose, polyvinylpyrrolidone, polytetrafluoroethylene, polyethylene, polypropylene, ethylene-propylene-dienter polymer (EPDM), sulfonated EPDM, styrene butadiene rubber, fluoro-rubber and various copolymer, or the like, but is not limited thereto.

The negative active material included in the negative active material layer 142 may generate electric energy by storing and releasing lithium ions moving from the positive electrode during discharging of the all-solid-state battery. Carbon-based material, silicon, silicon oxide, silicon-based alloy, silicon-carbon-based material composites, tin, tin-based alloy, tin-carbon composites, metal oxide or combinations thereof may be used as the negative active material, which may include lithium metal and/or lithium metal alloy.

The lithium metal alloy may include lithium and a metal/metalloid capable of alloying with lithium. For example, the metal/metalloid capable of alloying with lithium may be Si, Sn, Al, Ge, Pb, Bi, Sb, Si—Y alloy, Sn-AM alloy (AM is an alkali metal, an alkaline-earth metal, a Group 13 to 16 element, a transition metal, a transition metal oxide such as lithium titanium oxide (Li₄Ti₅O₁₂), a rare-earth element, or a combination thereof, excluding Sn), and MnOx (0<x≤2).

The element AM may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or combinations thereof.

In addition, the oxide of the metal/metalloid capable of alloying with lithium may be lithium titanium oxide, vanadium oxide, lithium vanadium oxide, SnO₂, SiOx (0<x<2), or the like. For example, the negative active material may include one or more an element selected from the group consisting of Group 13 to 16 elements of periodic table. For example, the negative active material may include one or more element selected from the group consisting of Si, Ge and Sn.

The carbon-based material may be crystalline carbon, amorphous carbon or a mixture thereof. The crystalline carbon may be graphite such as natural graphite or artificial graphite in amorphous, platy, flake, spherical or fibrous form. In addition, the amorphous carbon may be soft carbon (low temperature sintering carbon) or hard carbon, mesophase pitch carbide, calcined coke, graphene, carbon black, fullerene soot, carbon nanotube, carbon fiber, or the like, but is not limited thereto.

The silicon may be selected from the group consisting of Si, SiOₓ (0<x<2, e.g., 0.5 to 1.5), Sn, SnO₂, or silicon-containing metal alloy and a mixture thereof. The silicon-containing metal alloy may include, for example, silicon and one or more of Al, Sn, Ag, Fe, Bi, Mg, Zn, In, Ge, Pb, and Ti.

The negative active material selectively may include a conductive material and a binder.

The conductive material is not particularly limited as long as it has conductivity without causing chemical changes in the all-solid-state battery 100. For example, graphite such as a natural graphite or an artificial graphite; carbon-based material such as carbon black, acetylene black, ketjen black, channel black, furnace black, lamp black, summer black; conductive fiber such as carbon fiber or metal fiber; fluorinated carbon; metal component, such as lithium (Li), tin (Sn), aluminum (Al), nickel (Ni), copper (Cu), and oxide, nitride, fluoride, or the like thereof; conductive whiskers such as zinc oxide or potassium titanate; conductive metal oxide such as titanium oxide; the conductive material such as a polyphenylene derivative; or the like may be used.

The binder may be used to improve bonding strength between the active material and the conductive material. The binder may be polyvinylidene fluoride, polyvinyl alcohol, carboxymethylcellulose (CMC), starch, hydroxypropyl cellulose, regenerated cellulose, polyvinylpyrrolidone, polytetrafluoroethylene, polyethylene, polypropylene, ethylene-propylene-dienter polymer (EPDM), sulfonated EPDM, styrene butadiene rubber, fluoro-rubber, and various copolymers, or the like, but is not limited thereto.

The solid electrolyte layer 130 may be adjacently disposed between the positive active material layer 122 of the positive electrode layer 120 and the negative active material layer 142 of the negative electrode layer 140 in a stacking direction. Therefore, the positive electrode layers 120 and the negative electrode layers 140 are alternately disposed in the all-solid-state battery 100, and the solid electrolyte layers 130 may be provided and stacked between the positive electrode layers 120 and the negative electrode layers 140.

The solid electrolyte included in the solid electrolyte layer 130 may include a glass-ceramic electrolyte including lithium halogen (LiX, where X is a halogen element such as F, Br, Cl, I, or the like). Glass-ceramic (or crystallized glass) means that amorphous and crystalline are mixed crystallographically, such as peaks and halos observed in X-ray diffraction or electron diffraction. Therefore, the glass-ceramic electrolyte is an electrolyte in a state in which crystallization is partially progressed through sintering and amorphous and crystalline are mixed.

An amorphous material and two or more types of crystalline materials may be mixed in the glass-ceramic electrolyte. In addition, the crystalline included in the glass-ceramic electrolyte may include a crystalline phase of a lithium compound including lithium.

In the case of including the glass-ceramic electrolyte, high ionic conductivity may be implemented by sufficiently densifying after sintering.

The glass-ceramic electrolyte may include lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and chloride lithium (LiCI). As a specific example, the glass-ceramic electrolyte may include Li₂O—B₂O₃—SiO₂—P₂O₅—GeO₂—LiCl.

On the other hand, the solid electrolyte included in the solid electrolyte layer 130 may include lithium borosilicate-based electrolyte (hereinafter, may be referred to as an LBSO-based electrolyte). The LBSO-based electrolyte is an electrolyte in a glass state, and glass means crystallographically amorphous, such as halos observed in the X-ray diffraction or electron diffraction.

In the case of including the LBSO-based electrolyte, it is possible to lower the sintering temperature and maintain an amorphous state during sintering, such that high ionic conductivity may be implemented and the reactivity with the electrode is not great. The LBSO-based electrolyte may include lithium (Li), boron (B), silicon (Si), aluminum (Al), phosphorus (P), germanium (Ge), and sulfur(S).

In addition, the solid electrolyte included in the solid electrolyte layer 110 may be one or more selected from the group consisting of Garnet-type, Nasicon-type, LISICON-type, perovskite-type, and LiPON-type.

The Garnet-type solid electrolyte may mean lithium-lanthanum-zirconium-oxide (LLZO) represented by LiₐLa_{b}Zr_{c}O₁₂ such as Li₇La₃Zr₂O₁₂, and the NasicoN-type solid electrolyte may mean lithium-aluminum-titanium-phosphate (LATP) of Li₁₊ₓAlₓTi₂₋ₓ(PO₄)₃(0<x<1) in which Ti is introduced into Li₁₊ₓAlₓM₂₋ₓ(PO₄)₃(LAMP) (0<x<2, M=Zr, Ti, Ge) compound, lithium-aluminum-germanium-phosphate (LAGP) represented by Li₁₊ₓAlₓGe₂₋ₓ(PO₄)₃ (0<x<1) such as Li_{1.3}Al_{0.3}Ge_{1.7}(PO₄)₃ introduced with excessive lithium, and/or lithium-zirconium-phosphate (LZP) of LiZr₂(PO₄)₃.

In addition, the LISICON-type solid electrolyte is represented by xLi₃AO₄-(1'x)Li₄BO₄ (A: P, As, V, or the like, B: Si, Ge, Ti, or the like), and may mean solid solution oxides including Li₄Zn GeO₄₄, Li₁₀GeP₂O₁₂(LGPO), Li_{3.5}Si_{0.5}P_{0.5}O₄, Li_{10.42}Si (Ge)_{1.5}P_{1.5}Cl_{0.08}O_{11.92}, or the like, and solid solution sulfides including Li₂S—P₂S₅, Li₂S—SiS₂, Li₂S—SiS₂—P₂S₅, Li₂S—GeS₂, or the like, represented by Li₄₋ₓM_{1-y}M′_{y}S₄ (M=Si, Ge, and M′=P, Al, Zn, Ga).

In addition, the perovskite-based solid electrolyte may mean lithium-lanthanum-titanium-oxide (LLTO) represented by Li₃ₓLa_{2/3-x□1/3-2x}TiO₃ (0<x<0.16, □=vacancies) such as Li_{1/8}La_{5/8}TiO₃, and the rifone-based solid electrolyte may mean nitride such as lithium-phosphorus-oxynitride such as Li_{2.8}PO_{3.3}N_{0.46}.

The positive electrode layer 120, the solid electrolyte layer 130, and the negative electrode layer 140 may be stacked as aforementioned to thus configuring a cell stacked body of the all-solid-state battery 100. An outer insulating layer 135 for covering the positive electrode current collector 121 may be disposed on an upper outermost portion of the cell stacked body, and an outer insulating layer 136 for covering the negative electrode current collector may be disposed on a lower outermost portion. Protection layers 137 and 138 including an insulating material may be additionally disposed outside the outer insulating layers 135 and to prevent ion leakage and secure insulation performance.

One side edge of the positive electrode layer 120 (e.g., one side edge of the positive electrode current collector 121) may be exposed to one side surface (a right-side surface) of the cell stacked body, and one side edge of the negative electrode layer 140 (e.g., one side edge of the negative electrode current collector 141) may be exposed to the other side surface (a left-side surface) of the cell stacked body. The one side surface and the other side surface of the cell stacked body may be both side surfaces facing each other in the first direction (an x direction in the drawings) from among the planar direction.

An external positive electrode 161 may be disposed on the one side surface of the cell stacked body to be connected to the positive electrode layers 120, and an external negative electrode 162 may be disposed on the other side surface of the cell stacked body to be connected to the negative electrode layers 140. Margin portions 151 and 152 include a region between the positive electrode layer 120 and the external negative electrode 162, and a region between the negative electrode layer 140 and the external positive electrode 161. That is, the positive electrode margin portion 151 is the region between the external negative electrode 162 and the positive electrode layer 120, and the negative electrode margin portion 152 is the region between the external positive electrode 161 and the negative electrode layer 140.

A material with low ion conductivity and electron conductivity, that is, an insulating material may be provided on the positive electrode margin portion 151 and the negative electrode margin portion 152, and a material with ion conductivity (or electron conductivity) that is similar to ion conductivity (or electron conductivity) of the solid-state electrolyte. For example, in the case that a material having an ion conductivity (or electron conductivity) similar to the ion conductivity (or electron conductivity) of the solid electrolyte exists in this region, the material may be a material that is the same as or different from the solid electrolyte in another region. For another example, a material having ion conductivity (or electron conductivity) similar to the ion conductivity (or electron conductivity) of the solid electrolyte and an insulation material may coexist in this region.

The external positive electrode 161 may be a first external electrode, and the external negative electrode 162 may be a second external electrode.

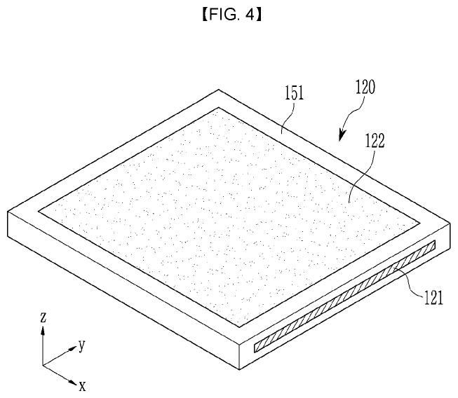

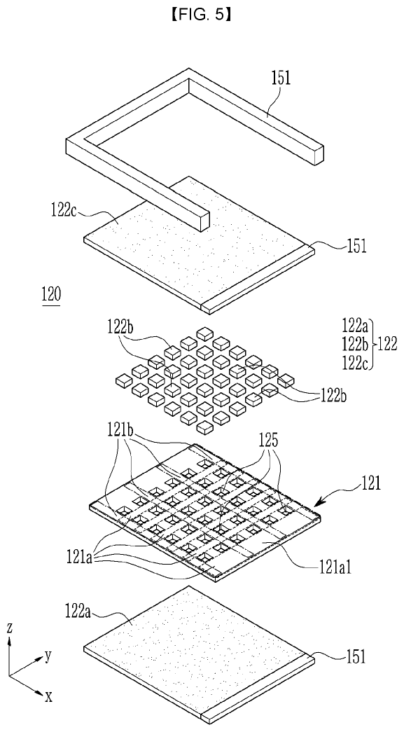

FIG. 4 shows a perspective view of a positive electrode layer in an all-solid-state battery shown in FIG. 1, and FIG. 5 shows an exploded perspective view of a positive electrode layer shown in FIG. 4.

Referring to FIG. 4 and FIG. 5, the positive electrode layer 120 includes a positive electrode current collector 121 and a positive active material layer 122. The positive electrode current collector 121 may include first current collecting portions 121a spaced from each other in the first direction (the x direction in the drawings) and second current collecting portions 121b spaced from each other in the second direction (the y direction in the drawings). The first current collecting portions 121a may cross the second current collecting portions 121b to be vertical to each other on a plane (an x-y plane). For example, the first current collecting portions 121a may extend to be parallel to the second direction (y direction in the drawing), and the second current collecting portions 121b may extend to be parallel to the first direction (x direction in the drawing).

When the first current collecting portions 121a cross the second current collecting portions 121b, distances between the current collecting portion are maintained as regular, thereby preventing degradation of products caused by concentration of charges.

Active material receiving portions 125 may be formed on the positive electrode current collector 121. The active material receiving portions 125 may be through holes formed by the first current collecting portions 121a and the second current collecting portions 121b, that is, the active material receiving portion 125 may be through holes formed between the first current collecting portions 121a and the second current collecting portions 121b when they cross each other. In other words, the first current collecting portions 121a and the second current collecting portions 121b may cross each other with the active material receiving portions 125 therebetween.

The positive electrode current collector 121 may be, for example, made of stainless steel, nickel (Ni), copper (Cu), tin (Sn), aluminum (Al) or alloys thereof, but is not limited thereto.

The positive electrode current collector 121 may be coated with an oxidation-resistant metal or an alloy film to prevent oxidation.

The positive electrode current collector 121 may be made of a carbon-based material. The positive electrode current collector 121 may be made of a conductive carbon material, and the conductive carbon material may be, for example, conductive fiber such as graphite, carbon nanotube (CNT), vapor grown carbon fiber (VGCF), or the like, or conductive carbon such as carbon black. For example, the positive electrode current collector 121 may include a sintering-type oxide glass electrolyte.

Meanwhile, one or more types of solid-state electrolytes may be included in the positive electrode current collector.

The active material receiving portions 125 may be arranged in the first direction (x direction in the drawing) and the second direction (y direction in the drawing), and may be formed at regular intervals therebetween. That is, the first current collecting portions 121a and the second current collecting portions 121b forming the active material receiving portions 125 may be arranged as a vertical lattice structure. The active material receiving portions 125 may respectively be through holes, and may have a cubic structure. When the active material receiving portions 125 have a cubic structure, they may have the same length, but are not limited thereto.

Both ends of the respective first current collecting portions 121a may contact one pair of second current collecting portions 121b disposed on an outermost side from among the second current collecting portions 121b in the planar direction on the plane (x-y plane). That is, one end of the first current collecting portions 121a may contact the second current collecting portion 121b disposed on an outer portion of one side on the plane (x-y plane), and the other end may contact the second current collecting portion 121b disposed on an outer portion of the other side on the plane (x-y plane).

The respective thicknesses of the first current collecting portions 121a may be 1 μm to 50 μm, their mutual gaps may be 1 μm to 50 μm, and their heights may be 1 μm to 100 μm, but are not limited thereto.

Both ends of the second current collecting portions 121b may contact the one pair of first current collecting portions 121a disposed on the outermost side from among the first current collecting portions 121a in the planar direction on the plane (x-y plane). That is, the one ends of the second current collecting portions 121b may contact the first current collecting portion 121a disposed on the outer portion of one side on the plane (x-y plane), and the other ends may contact the first current collecting portion 121a disposed on the outer portion of the other side on the plane (x-y plane).

The respective thicknesses of the second current collecting portions 121b may be 1 μm to 50 μm, their mutual gaps may be 1 μm to 50 μm, and their heights may be 1 μm to 100 μm, but are not limited thereto.

The respective thicknesses of the first current collecting portions 121a may be 1 μm to 50 μm, their mutual gaps may be 1 μm to 50 μm, and their heights may be 1 μm to 100 μm, but are not limited thereto.

One pair of the first current collecting portions disposed on the outer portion from among the first current collecting portions 121a and one pair of the second current collecting portion disposed on the outer portion from among the second current collecting portions 121b may contact each other at both the ends. The current collector 121 may have a quadrangular frame shape by the one pair of the first current collecting portions 121a and the one pair of the second current collecting portions 121b disposed on the outer portion.

From among the first current collecting portions 121a, an edge of the first current collecting portion 121a1 (or access current collecting portion) disposed on the outermost portion (rightmost side) of one side may be exposed to one lateral surface (right-hand surface) of the cell stacked body and may contact the external positive electrode 161. The positive active material layer 122 may be disposed on both surfaces of the positive electrode current collector 121 and may fill the active material receiving portions 125. That is, the positive active material layer 122 may be made of a multi-layer structure including a first layer 122a disposed on a lower surface of the positive electrode current collector 121, a second layer 122b for filling the active material receiving portions 125, and a third layer 122c disposed on an upper surface of the positive electrode current collector 121. The first layer 122a and the third layer 122c may be integrally connected to each other by the second layer 122b.

The positive electrode margin portion 151 may be disposed on a remaining edge that is exclusive of the edge of the access current collecting portion 121a1 to be connected to the external positive electrode 161 on the positive electrode layer 120. For example, the positive electrode margin portion 151 may be disposed on three edges that are exclusive of the edge on one side (or right side) on which the edge of the access current collecting portion 121a1 is disposed from among the four edges of the positive electrode layer 120. The positive electrode margin portion 151 may contact both surfaces (an upper surface and a lower surface) of the access current collecting portion 121a1. The positive electrode margin portion 151 disposed on both the surfaces of the access current collecting portion 121a1 may contact the first layer 122a and the third layer 122c of the positive active material layer 122 on the plane (x-y plane).

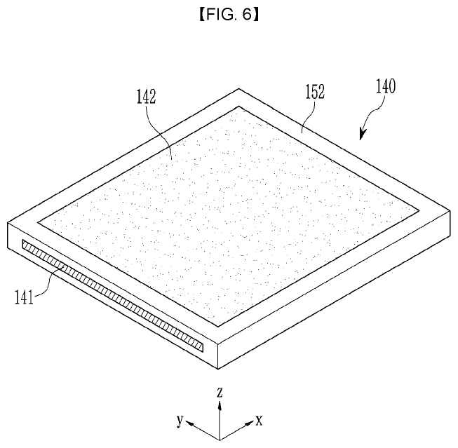

FIG. 6 shows a perspective view of a negative electrode layer in an all-solid-state battery shown in FIG. 1, and FIG. 7 shows an exploded perspective view of a negative electrode layer shown in FIG. 6.

Referring to FIG. 6 and FIG. 7, the negative electrode layer 140 includes a negative electrode current collector 141 and a negative active material layer 142. The negative electrode current collector 141 may include first current collecting portions 141a spaced from each other in the first direction (x direction in the drawing) and second current collecting portions 141b spaced from each other in the second direction (y direction in the drawing). The first current collecting portions 141a and the second current collecting portions 141b may cross each other to be vertical to each other. For example, the first current collecting portions 141a may extend to be parallel to the second direction (y direction in the drawing), and the second current collecting portions 141b may extend to be parallel to the first direction (x direction in the drawing).

When the first current collecting portions 141a and the second current collecting portions 141b cross each other, a regular distance between the current collecting portions is maintained, thereby preventing degradation of products caused by concentration of charges.

Active material receiving portions 145 may be formed on the negative electrode current collector 141.

The active material receiving portions 145 may be through holes formed by the first current collecting portions 141a and the second current collecting portions 141b, that is, the active material receiving portion 145 may be through holes formed between the first current collecting portions 141a and the second current collecting portions 141b when they cross each other. In other words, the first current collecting portions 141a and the second current collecting portions 141b may cross each other with the active material receiving portions 145 therebetween.

The negative electrode current collector 141 may be, for example, made of stainless steel, nickel (Ni), copper (Cu), tin (Sn), aluminum (Al) or alloys thereof, but is not limited thereto.

The negative electrode current collector 141 may be coated with an oxidation-resistant metal or an alloy film to prevent oxidation.

The negative electrode current collector 141 may be made of a conductive carbon-based material in a like way of the positive electrode current collector 121, and may include at least one type of the solid-state electrolyte. For example, the negative electrode current collector 121 may include a sintering-type oxide glass electrolyte. The negative electrode current collector 141 may be the same as the negative active material.

The active material receiving portions 145 may be arranged in the first direction (x direction in the drawing) and the second direction (y direction in the drawing) and may be formed at regular intervals therebetween. That is, the first current collecting portions 121a and the second current collecting portions 121b forming the active material receiving portions 125 may be arranged as a vertical lattice structure. The active material receiving portion 125 may be through holes in a cubic structure, and the active material receiving portions 125 may have the same length, but are not limited thereto.

Both ends of the respective first current collecting portions 141a may contact one pair of second current collecting portions 141b disposed on an outermost side from among the second current collecting portions 141b in the planar direction on the plane (x-y plane). That is, one end of the first current collecting portions 141a may contact the second current collecting portion 141b disposed on an outer portion of one side on the plane (x-y plane), and the other end may contact the second current collecting portion 141b disposed on an outer portion of the other side on the plane (x-y plane).

The respective thicknesses of the first current collecting portions 141a may be 1 μm to 50 μm, their mutual gaps may be 1 μm to 50 μm, and their heights may be 1 μm to 100 μm, but are not limited thereto.

Both ends of the second current collecting portions 141b may contact the one pair of first current collecting portions 141a disposed on the outermost side from among the first current collecting portions 141a in the planar direction on the plane (x-y plane). That is, the one ends of the second current collecting portions 141b may contact the first current collecting portion 141a disposed on the outer portion of one side on the plane (x-y plane), and the other ends may contact the first current collecting portion 141a disposed on the outer portion of the other side on the plane (x-y plane).

The respective thicknesses of the second current collecting portions 141b may be 1 μm to 50 μm, their mutual gaps may be 1 μm to 50 μm, and their heights may be 1 μm to 100 μm, but are not limited thereto.

One pair of the first current collecting portions disposed on the outer portion from among the first current collecting portions 141a and one pair of the second current collecting portion disposed on the outer portion from among the second current collecting portions 141b may contact each other at both the ends. The current collector 121 may have a quadrangular frame shape by the one pair of the first current collecting portions 141a and the one pair of the second current collecting portions 141b disposed on the outer portion.

From among the first current collecting portions 141a, the first current collecting portion 141a1 (or access current collecting portion) disposed on the outermost portion (leftmost side) of one side may be exposed to one lateral surface (left-hand surface) of the cell stacked body and may contact the external negative electrode 162.

The negative active material layer 142 may be disposed on both surfaces of the negative electrode current collector 141 and may fill the active material receiving portions 145. That is, the negative active material layer 142 may be made of a multi-layer structure including a first layer 142a disposed on a lower surface of the negative electrode current collector 141, a second layer 142b for filling the active material receiving portions 145, and a third layer 142c disposed on an upper surface of the negative electrode current collector 141. The first layer 142a and the third layer 142c may be integrally connected to each other by the second layer 142b.

The negative electrode margin portion 152 may be disposed on a remaining edge that is exclusive of the edge of the access current collecting portion 141a1 to be connected to the external negative electrode 162 on the negative electrode layer 140. For example, the negative electrode margin portion 152 may be disposed on three edges that are exclusive of the edge on one side (or left side) on which the edge of the access current collecting portion 141a1 is disposed from among the four edges of the negative electrode layer 140. The negative electrode margin portion 152 may contact both surfaces (an upper surface and a lower surface) of the access current collecting portion 141a1. The negative electrode margin portion 152 disposed on both the surfaces of the access current collecting portion 141a1 may contact the first layer 142a and the third layer 142c of the negative active material layer 142 on the plane (x-y plane).

Referring to FIG. 4 to FIG. 7, regarding the positive electrode layer 120 and the negative electrode layer 140, the current collectors 121 and 141 have active material receiving portions 125 and 145 and receive the electrode active material layers 122 and 142. The current collectors 121 and 141 responsible for electron conduction do not directly contribute to a capacity of the all-solid-state battery 100, but in the all-solid-state battery 100 according to the present embodiment, the current collectors 121 and 141 implement an effect of filling portions of their volume with an active material. Thus, the capacity may be increased by increasing an amount of the active material without expanding a volume of the all-solid-state battery 100.

In a conventional all-solid-state battery, the current collector is formed in a simple quadrangular sheet shape, and the active material layer is disposed on at least one surface of the sheet-shaped current collector.

When the conventional all-solid-state battery and the all-solid-state battery 100 of the embodiment have the same volume, the all-solid-state battery 100 of the embodiment may have a larger amount of active material than the conventional all-solid-state battery so that the all-solid-state battery 100 of the embodiment increases energy density and capacity compared with the conventional all-solid-state battery.

For example, when an area of each of the first and second layers disposed on both surfaces of the current collector among the active material layer is 0.9025 cm² and a thickness of each of the first and second layers is 0.0007 cm, a volume of each of the first and second layers is 0.000632 cm³. When a ratio of the active material in the volume of each of the first and second layers is 55 vol % and a capacity of lithium cobalt oxide (LCO or LiCoO2) is 670.6 mAh/cm³, a capacity of each of the first and second layers is calculated to be approximately 0.233 mAh.

When the sheet-type current collector with no through holes has the area of 0.9025 cm² and the thickness of 0.0003 cm, the volume of the current collector becomes 0.000271 cm³.

Regarding the current collector, assuming that the through hole occupies 50% of the volume of the current collector, and the second layer of the active material layer is filled in the through hole, capacity of the second layer is calculated to be about 0.05 mAh. In a like way, assuming that the through hole occupies 70% of the volume of the current collector, when the second layer of the active material layer is filled in the through hole, the capacity of the second layer is calculated to be about 0.07 mAh.

As a result, it is found that, when the second layer occupies 50% of the current collector volume, the electrode layer shows an increase of the capacity by about 10.7%, and when the second layer occupies 70% of the current collector volume, the electrode layer shows an increase of the capacity by about 15%.

A method for manufacturing the above-configured all-solid-state battery 100 will now be described.

The method for manufacturing the all-solid-state battery 100 according to an embodiment includes forming a positive electrode layer 120 on the solid electrolyte layer 130 (i.e., a first stage), forming a negative electrode layer 140 on the solid electrolyte layer 130 (i.e., a second stage), and alternately stacking the positive electrode layer 120 and the negative electrode layer 140 with the solid electrolyte layer 130 therebetween (i.e., a third stage). The positive electrode layer 120 may be the first electrode layer, and the negative electrode layer 140 may be the second electrode layer. The first stage and the second stage are only divided in order for convenience, and do not mean a strict temporal precedence relationship.

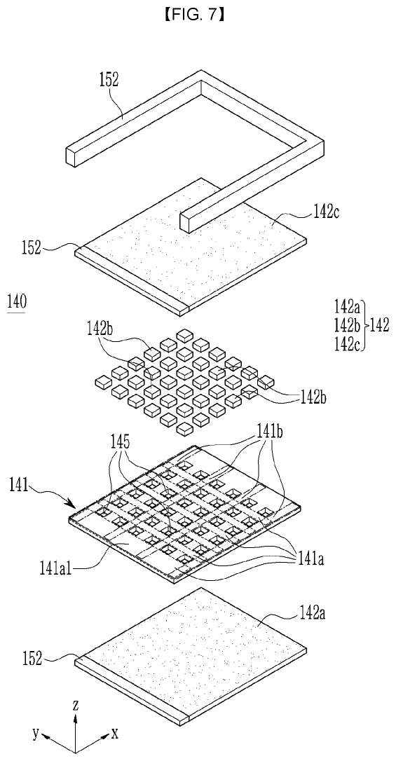

FIG. 8 to FIG. 12 show process of the first stage.

Referring to FIG. 8, a solid electrolyte layer 130 may be provided, an active material paste may be printed on the solid electrolyte layer 130 and may then be dried to form a first layer 122a. The first layer 122a may be a first active material layer. An insulating paste may be printed on the solid electrolyte layer 130 and may be dried to form a first margin portion 151a. The first margin portion 151a may contact one side (right side) edge of the first layer 122a on the plane (x-y plane). Meanwhile, the first margin portion 151a may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

Referring to FIG. 9, a conductive paste is printed on the first layer 122a and the first margin portion 151a and is dried to form the current collector 121. The current collector 121 may include first current collecting portions 121a spaced from each other in the first direction (x direction in the drawing) and second current collecting portions 121b spaced from each other in the second direction (y direction in the drawing) and vertical to the first current collecting portions 121a. The first current collecting portions 121a may extend in parallel to the second direction (y direction in the drawing), and the second current collecting portions 121b may extend in parallel to the first direction (x direction in the drawing). Active material receiving portions 125 that is the through holes may be formed by the first current collecting portions 121a and the second current collecting portions 121b.

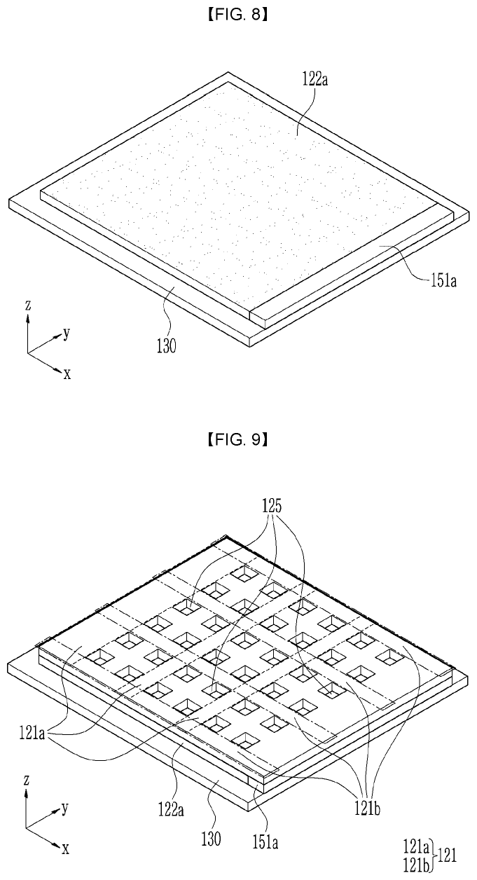

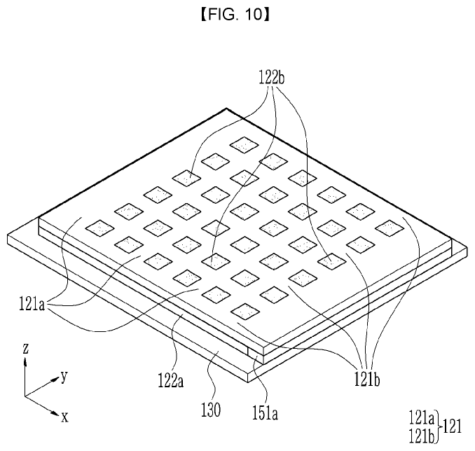

Referring to FIG. 10, an active material paste is printed on the active material receiving portions 125 and is dried to form a second layer 122b. The second layer 122b may be a second active material layer. The second layer 122b contacts the first layer 122a in a stacking direction, and may fill the active material receiving portions 125 without gaps therein.

Referring to FIG. 11, an active material paste is printed on the current collector 121 and the second layer 122b and is dried to form a third layer 122c. The third layer 122c may be a third active material layer. The third layer 122c may cover some of the first current collecting portions 121a, all of the second layer 122b, and all of the second current collecting portions 121b. The third layer 122c may contact the second layers 122b in the stacking direction. An insulating paste may be printed on the access current collecting portion 121a1 and may be dried to form a second margin portion 151b. The second margin portion 151b may contact one side (right side) edge of the third layer 122c on the plane (x-y plane). Meanwhile, the second margin portion 151b may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

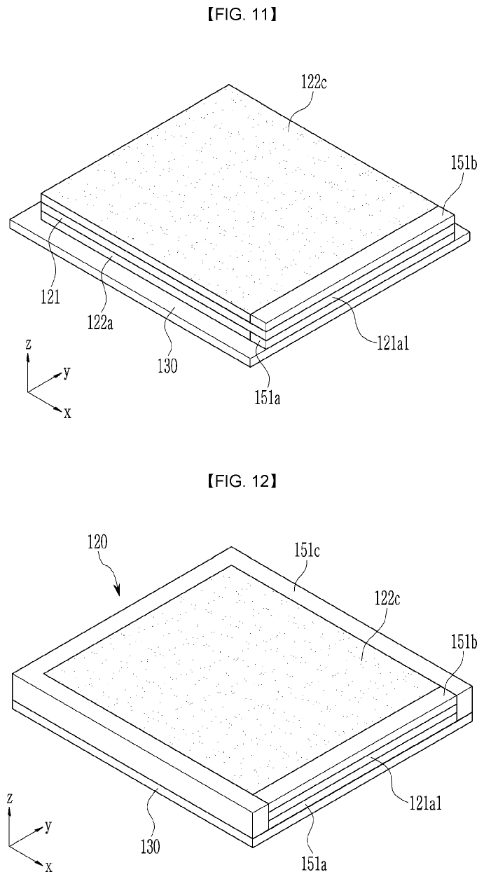

Referring to FIG. 12, an insulating paste may be printed on three edges that are exclusive of the one side (right side) edge on which the edge of the access current collecting portion 121a1 is disposed from among the four edges of the stacked body including the first to third layers 122a, 122b, and 122c, the first and second margin portions 151a and 152b, and the current collector 121, and may be dried to form a third margin portion 151c. The third margin portion 151c may contact the three edges of the stacked body on the plane (x-y plane), and the thickness of the third margin portion 151c may be equal to the thickness of the stacked body. Meanwhile, the third margin portion 151c may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

FIG. 13 to FIG. 17 shows processes of the second stage.

Referring to FIG. 13, a solid electrolyte layer 130 is provided, and an active material paste is printed on the solid electrolyte layer 130 and is dried to form a first layer 142a. The first layer 142a may be a first active material layer. An insulating paste is printed on the solid electrolyte layer 130 and is dried to form a first margin portion 152a. The first margin portion 152a may contact one side (left side) edge of the first layer 142a on the plane (x-y plane). Meanwhile, the first margin portion 152a may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

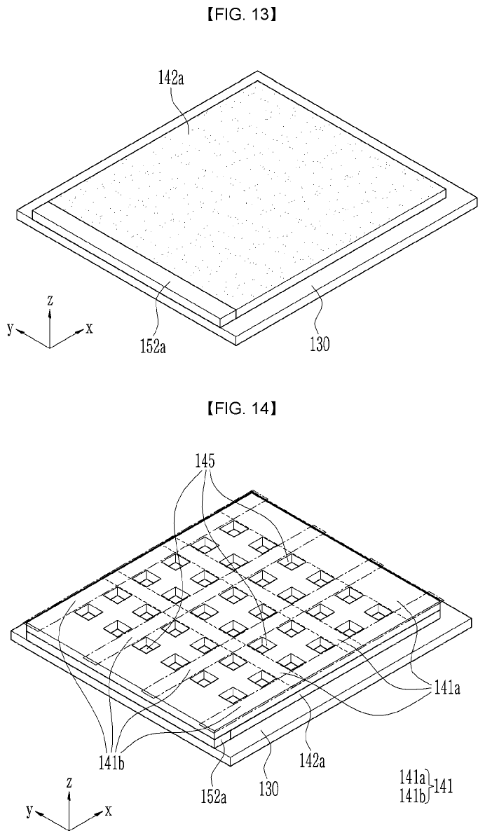

Referring to FIG. 14, a conductive paste is printed on the first layer 142a and the first margin portion 152a and is dried to form a current collector 141. The current collector 141 may include first current collecting portions 141a spaced from each other in the first direction (x direction in the drawing) and second current collecting portions 141b spaced from each other in the second direction (y direction in the drawing) and vertical to the first current collecting portions 141a. The first current collecting portions 141a may extend in parallel to the second direction (y direction in the drawing), and the second current collecting portions 141b may extend in parallel to the first direction (x direction in the drawing). Active material receiving portions 125 that are through holes may be formed by the first current collecting portions 141a and the second current collecting portions 141b.

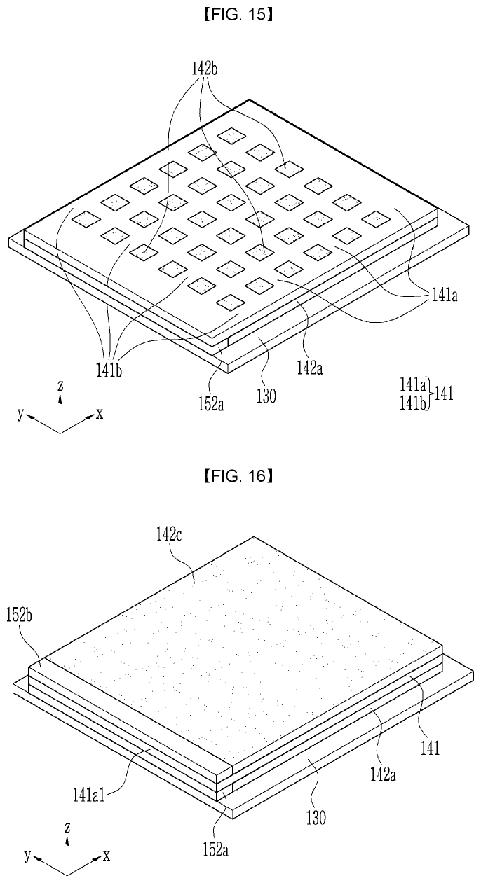

Referring to FIG. 15, an active material paste is printed on the active material receiving portion 145 and is dried to form a second layer 142b. The second layer 142b may be a second active material layer. The second layer 142b may contact the first layer 142a in the stacking direction, and may fill the active material receiving portions 145 without gaps.

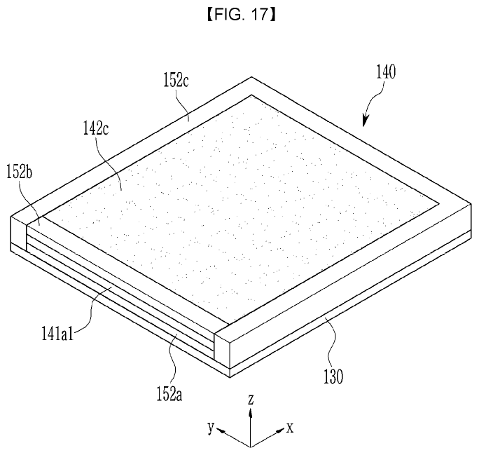

Referring to FIG. 15 and FIG. 16, an active material paste may be printed on the current collector 141 and the second layer 142b and may be dried to form a third layer 142c. The third layer 142c may be a third active material layer. The third layer 142c may cover some of the first current collecting portions 141a, all of the second layers 142b, and all of the second current collecting portions 141b. The third layer 142c may contact the second layers 142b in the stacking direction. An insulating paste may be printed on the access current collecting portion 141a1 and may be dried to form a second margin portion 152b. The second margin portion 152b may contact one side (left side) edge of the third layer 142c on the plane (x-y plane). Meanwhile, the second margin portion 152b may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

Referring to FIG. 17, an insulating paste is printed on the three edges that are exclusive of one side (left side) edge on which the edge of the access current collecting portion 141a1 is disposed from among the four edges of the stacked body including the first to third layers 142a, 142b, and 142c, the first and second margin portions 152a and 152b, and the current collector 141, and may be dried to form a third margin portion 152c. The third margin portion 152c may contact the edges of the stacked body on the plane (x-y plane), and the thickness of the third margin portion 152c may be equal to the thickness of the stacked body. Meanwhile, the third margin portion 152c may be made of a material having ion conductivity (or electron conductivity) that is similar to ion conductivity (or electron conductivity) of the solid-state electrolyte, or may be made of a material having ion conductivity (or electron conductivity) that is similar to ion conductivity (or electron conductivity) of the solid-state electrolyte and an insulating material.

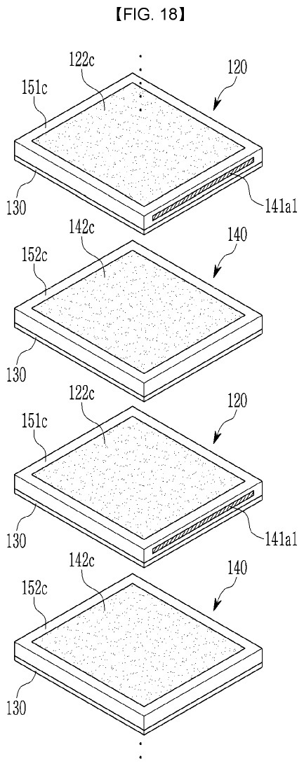

FIG. 18 shows a process of the third stage.

Referring to FIG. 18, the positive electrode layer 120 and the negative electrode layer 140 may be alternately stacked with the solid electrolyte layer 130 therebetween to configure a cell stacked body. An outer insulating layer and a protection layer (not shown) may be additionally arranged on an upper outermost portion of the cell stacked body, and an outer insulating layer and a protection layer (not shown) may be additionally arranged on a lower outermost portion of the cell stacked body. An external positive electrode and an external negative electrode (not shown) may be additionally arranged on both sides of the cell stacked body to configure the all-solid-state battery.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

100: all-solid-state battery
120: positive electrode layer
121: positive electrode current collector
122: positive active material layer
140: negative electrode layer
141: negative electrode current collector
142: negative active material layer
125, 145: active material receiving portion
121a, 141a: first current collecting portion
121b, 141b: second current collecting portion
130: solid electrolyte layer
135, 136: outer insulating layer
137, 138: protection layer
151: first margin portion
152: second margin portion
161: external positive electrode
162: external negative electrode

1. An all-solid-state battery comprising:
a solid electrolyte layer; and
a first electrode layer and a second electrode layer arranged with the solid electrolyte layer therebetween,
wherein the first electrode layer and second electrode layer respectively comprise:
a current collector including first current collecting portions spaced from each other by through holes in a first direction and second current collecting portions spaced from each other by the through holes in a second direction that is vertical to the first direction and crossing the first current collecting portions, and
an electrode active material layer including a first layer disposed on one surface of the current collector and a second layer disposed in the through holes in the current collector.

2. The all-solid-state battery of claim 1, wherein
the first current collecting portions extend in parallel to the second direction, and
the second current collecting portions extend in parallel to the first direction.

3. The all-solid-state battery of claim 1, wherein
the current collector includes one pair of first current collecting portions disposed on an outer portion from among the first current collecting portions and one pair of second current collecting portions disposed on an outer portion from among the second current collecting portions to contact each other at both ends to have a quadrangular frame shape.

4. The all-solid-state battery of claim 1, further comprising:
a second external electrode disposed on one sides of the first electrode layer and the second electrode layer to be in contact with a first current collecting portion disposed on an outermost portion from among the first current collecting portions of the second electrode layer.

5. The all-solid-state battery of claim 4, further comprising:
a first external electrode disposed on other sides of the first electrode layer and the second electrode layer to be in contact with a first current collecting portion disposed on an outermost portion from among the first current collecting portions of the first electrode layer.

6. The all-solid-state battery of claim 1, wherein
the electrode active material layer further comprises a third layer disposed on the other surface of the current collector, and
the first layer and the third layer of the electrode active material layer are connected to each other by the second layer.

7. The all-solid-state battery of claim 1, wherein
the through holes are arranged in an array in the first direction and the second direction.

8. An all-solid-state battery comprising:
a solid electrolyte layer; and
a first electrode layer and a second electrode layer arranged with the solid electrolyte layer therebetween,
wherein the first electrode layer and the second electrode layer respectively comprise:
a current collector comprising an active material receiving portion, and
an electrode active material layer disposed in the active material receiving portion and disposed on at least one surface of the current collector, and
the active material receiving portion includes through holes spaced from each other in a first direction and a second direction that is vertical to the first direction in the current collector.

9. The all-solid-state battery of claim 8, wherein
the current collector includes first current collecting portions spaced from each other in the first direction with the through holes therebetween, and second current collecting portions spaced from each other in the second direction with the through holes therebetween.

10. The all-solid-state battery of claim 9, wherein
the first current collecting portions and the second current collecting portions have portions crossing each other.

11. The all-solid-state battery of claim 8, wherein
the electrode active material layer comprises a first layer disposed on one surface of the current collector, a second layer disposed in the through holes, and a third layer disposed on the other surface of the current collector, and
the first layer and the third layer are integrally connected to each other by the second layer.

12. The all-solid-state battery of claim 8, wherein
the through holes are arranged in an array in the first direction and the second direction.

13. A method for manufacturing an all-solid-state battery comprising:
forming an electrode layer on a solid electrolyte layer; and
repeatedly stacking the solid electrolyte layer and the electrode layer,
wherein the forming of the electrode layer comprises:
forming a first active material layer on the solid electrolyte layer,
forming a current collector having through holes in the first active material layer,
forming second active material layers to fill the through holes, and
forming a third active material layer on the current collector and the second active material layers, and
the forming of the current collector includes forming first current collecting portions spaced from each other in the first direction and second current collecting portions spaced from each other in a second direction that is vertical to the first direction and crossing the first current collecting portions.

14. The method of claim 13, wherein
the first current collecting portions are formed to be parallel to the second direction, and
the second current collecting portions are formed to be parallel to the first direction.

15. The method of claim 14, wherein
the forming of the current collector includes forming one pair of first current collecting portions disposed on an outer portion from among the first current collecting portions and one pair of second current collecting portions disposed on an outer portion from among the second current collecting portions to contact each other at both ends and have a quadrangular frame shape.

16. The method of claim 13, wherein
the through holes are arranged in an array in the first direction and the second direction.
